(19) United States
(12) Patent Application Publication
(10) Pub. No.: US 2009/0151963 A1
(43) Pub. Date: Jun. 18, 2009

(54) Method of Preventing or Extinguishing Fires

(76) Inventor: Edwin T. Sortwell, St. Simons Island, GA (US)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 12/334,143

(22) Filed: Dec. 12, 2008

Related U.S. Application Data
(60) Provisional application No. 61/013,577, filed on Dec. 13, 2007.

(51) Int. Cl. A62C 3/00

(52) U.S. Cl. 169/45

(57) ABSTRACT

In the prevention of the spread of fires and for directly fighting fires, a cross-linked, water-swellable additive polymer in a vegetable oil dispersion is added to firefighting water. The additive has the properties of absorbing large quantities of water, high viscosity for adherence to vertical and horizontal surfaces, and retention of sufficient fluidity to be educted in standard firefighting equipment. The method of adding this additive to the firefighting water by eduction, pumping, or batch addition to the source water is also disclosed.

### CROSS REFERENCE TO RELATED APPLICATION

The priority benefit of U.S. Provisional Application Ser. No. 61/013,577 filed Dec. 13, 2007, is claimed.

### BACKGROUND OF THE INVENTION

1. Field of the Invention

The invention relates generally to methods for preventing and/or extinguishing fires and, more specifically, to methods for applying water-laden polymer particles to a surface to prevent and/or extinguish fires.

2. Related Technology

Water is commonly used to extinguish fires and to prevent the spread thereof to nearby structures. Water has several beneficial effects when applied to a fire, including heat removal and oxygen deprivation. When water is directed at a structure adjacent a fire to prevent its spread thereto, the fire must provide enough heat to evaporate the water on (or in the materials of) the adjacent structure before the adjacent structure can reach its combustion or ignition temperature.

One disadvantage to using water to prevent a fire from spreading to a nearby structure is that most of the water directed at the structure does not soak into the structure to provide fire protection, but rather tends to run off the structure to the ground. Consequently, a significant quantity of water is wasted. Another disadvantage is that any water that does soak into the structure provides only limited protection against the fire because most structures only absorb a limited amount of water, and that limited amount of absorbed water quickly evaporates. Therefore, significant manpower must be expended to continuously reapply water on nearby structures to provide them with continuing fire protection.

A disadvantage to using water to extinguish fires is that a considerable amount of the water does not directly fight or extinguish the fire because of the run-off problem described above. Another disadvantage to using water in extinguishing fires is that the water sprayed directly on the fire evaporates at an upper level of the fire, with the result that significantly less water than is applied is able to penetrate sufficiently to extinguish the base of the fire.

To address the foregoing disadvantages of using water (by itself) to fight fires, U.S. Pat. No. 5,190,110 to von Blücher et al. describes using an aqueous system comprising dry absorbent polymers to extinguish and/or prevent fires. The polymer particles have particle sizes from 20 microns to 500 microns, and are dispersed in water by stirring or pumping, such that the resultant viscosity does not exceed 100 centipoises (cps). This system contains discrete polymer particles that absorb water, without being soluble in water. Thus, the particles are entrained in the water, permitting their application directly to a fire. The dry, solid granular particles are typically pre-mixed with the water source. Alternatively, the dry, solid granular particles can also be added directly in advance of the nozzle. This alternative method does not provide sufficient time for the particles to swell and, consequently, the viscosity is not increased sufficiently to allow the particles to adhere to surfaces.

U.S. Pat. No. 4,978,460 to von Blucher et al. also describes using an aqueous system comprising dry absorbent polymers to extinguish and/or prevent fires. The dry, solid polymer particles of the '460 patent are encased by a water-soluble release agent to prevent agglutination of the particles. The time that it takes for the encapsulated solid granular particles to swell (i.e., expand from the absorption of water) ranges from ten seconds to several minutes. When fighting a fire with typical hose lengths, ten seconds is longer than practical for the water to be retained in a fire hose. Thus, when such encased polymer particles are used with standard fire-fighting equipment, there is not sufficient time for the particles to swell, and the viscosity is not increased sufficiently to allow the particles to adhere to surfaces.

U.S. Pat. No. 3,758,641 to Zweigle also describes using dry, solid, granular polymer particles with high water absorption in firefighting applications. Use of the disclosed particles is best accomplished with special, additional firefighting equipment.

Due to the dry, solid, granular nature of the aforementioned state-of-the-art firefighting, water-absorbent polymeric particles, it is difficult, if not impossible, to use such polymers in many firefighting applications. For example, eduction of such polymers into a standard firefighting hose with standard equipment is nearly impossible because of the particulate nature of such polymers. Moreover, the dry, solid nature of the polymers promotes agglutination of the particles and subsequent blockage of water flow from the firefighting hose. It is therefore sometimes necessary to provide special equipment such as “pumps and spray nozzles adapted for handling for such materials” to use the dry, solid granular particles in firefighting applications (see, for example, the '641 patent to Zweigle).

Additionally, if a natural source of water, such as a creek or a river, is to be used as the water source, it is impossible to pre-mix the polymer by batch adding it to the water source. For example, if one poured the polymer additive into a stream or river, most of the polymer additive will simply flow past the point of suction of the water for use in combating fires.

U.S. Pat. No. 7,189,337 to Sortwell describes a method of fire fighting by a gel produced from a dispersion of dry, ground superabsorbent particles in a vegetable oil carrier. The product of Sortwell '337 produces a very effective firefighting gel. However, the most effective formulation [column 9, formulation (4)] in Sortwell '337 has a viscosity in the range of 6000 centipoise (cps), a molasses-like consistency. The purpose of this high viscosity is to provide suspension stability, but as a result, heavy-duty, professional firefighting equipment is necessary to impart the necessary shear to produce an instant gel when the product is added to water. After prolonged storage, mixing to ensure a homogenous product is hindered by the high viscosity. The surfactant used in Sortwell '337 facilitates the dispersion of the ground superabsorbent polymer in the oil carrier. However, the hydrophilic/lipophilic balance (HLB) conferred by the surfactant is specified to be less than about 8. The HLB of the dispersing surfactant in the formulation identified above [Sortwell '337, column 9, formulation (4)] is 4.3.

The low HLB formulation produces an effective gel when sheared into water with high energy. The gel adheres well to vertical structures and is an effective fire-prevention coating. But because of the low HLB (less than about 8) of the surfactant, the gel is lipophilic (“oil-loving”). This characteristic does not diminish the formulation's fire-prevention effectiveness, but it does mean that removing residual gel from structures or vegetation can be extremely difficult. Simple water washing is not effective and the residual oil film left after water washing, or even after high-pressure surfactant washing, may be deleterious.

### SUMMARY OF THE INVENTION

The invention provides a vegetable oil dispersion containing a dry, ground, cross-linked, water-swellable polymer for use in preventing and/or extinguishing fires. Advantageously, the dispersion is easily mixed with a water supply. Moreover, the dispersion can be combined with water to provide a water-additive mixture with sufficiently high viscosity such that the mixture readily adheres to vertical and horizontal surfaces in functional thickness. Additionally, the polymer contained in the dispersion has a very short swell time (to absorb the water), and is easily educted into a fire hose through the use of standard firefighting equipment. Moreover, because the dispersion of the disclosure comprises vegetable oil, its use as an additive for fighting fires is environmentally favored relative to mineral oil emulsion-based polymers.

In one embodiment of the invention, a method of applying water-laden polymer particles to a surface to prevent and/or extinguish a fire comprises (a) adding a dispersion comprising a vegetable oil, a surfactant system having a net HLB value above about 9.5, and a dry, ground, cross-linked, water-swellable polymer to water to form a water-additive mixture containing water-laden polymer particles, the oil, the particle size, and the amount of polymer being selected to result in the formation of a gel that is easily removable from a surface by washing with water; and, (b) directing the water-additive mixture onto a surface to prevent and/or extinguish a fire.

### BRIEF DESCRIPTION OF THE DRAWINGS

FIG. 1 is an illustration of typical equipment used to apply polymer particles to a surface to prevent and/or extinguish a fire; and,

FIG. 2 is a schematic representation illustrating an embodiment of the disclosure.

### DETAILED DESCRIPTION

The disclosed methods utilize a water additive to prevent and/or extinguish a fire. The additive is a dispersion containing a vegetable oil and a cross-linked, water-swellable polymer. In a preferred embodiment, the dispersion is produced by dispersing a ground, dry water-swellable polymer in vegetable oil, with appropriate hydrophilic, but oil soluble, surfactant(s), and a stabilizing agent. Preferably, the dispersion is a dry, cross-linked polymer of at least one hydrophilic monomer dispersed in vegetable oil. Typically, the polymer is a copolymer of acrylamide and acrylic acid derivatives (e.g., an acrylate salt). Preferably, the polymer is a terpolymer of an acrylate salt, acrylamide, and 2-acrylamido-2-methylpropanesulfonic acid (AMPS) salt. The polymer particles resulting from the polymerization are generally ground to a particle size of 97% less than 20 microns/100% less than 30 microns, preferably with a mean value of about 9.2 microns. This is a significantly smaller particle than that described in Sortwell '337 results in an improved gel coating.

Virtually any water-insoluble vegetable oil may be used to prepare the dispersion. Preferably, the vegetable oil is rapeseed oil (including its refined form, canola oil).

A gel is typically formed after the dispersion is added to the fire-fighting water. As a result of the hydrophilic emulsifier(s), immobilized gel formation occurs in less than three seconds. The gel typically has a viscosity of at least about 100 cps, preferably at least about 500 cps, up to about 50,000 cps. “Immobilized” gel formation means the concentration of the dispersion in water is such that the gel thickens to the point where it will adhere to a vertical surface on contact.

Surfactants, or a blend of surfactants, with a net HLB of 9.5 or above may be used to aid in both the dispersion of the dry polymer particles in the vegetable oil and, most importantly, in producing a gel which forms very rapidly in water with a minimum of shear and is easily removed by a simple water wash after it has been applied. Particularly suitable surfactants, having net HLB values above 9.5, are: (a) the TERGITOL 15-S series from Dow Chemical Company and particularly a blend of TERGITOL 15-S-3/TERGITOL 15-S-7, blended to a net HLB of 10.52; or (b) T-MAZ 65K from BASF Corporation, HLB 11. T-MAZ 65K is particularly suitable since it is used in foods such as cakes and icings. The TERGITOL NP series from Dow Chemical Company can also be blended to produce effective HLBs, but their nonylphenol ethoxylate contents pose health and environmental concerns.

The selection of surfactant, or surfactant blends, is determined by the surfactant's or blend's effectiveness in dry polymer dispersion and in production of gel which both adheres to vertical surfaces and, most importantly, is easily removed from such surfaces by simple water washing to produce an oil-free surface. In addition to these functions, optimal surfactant selection also results in a significant reduction in the viscosity of the dispersion, while still maintaining dispersion stability. Lower dispersion viscosity in turn means even less energy is required for rapid gel formation. The dispersion of Sortwell '337 reaches high gel viscosity quickly at the coating thicknesses required to adhere to vertical surfaces, but at the lower gel concentrations (and thus lower viscosities, e.g. 800 to 1200 cps) required for aerial fire fighting applications, the last 10% to 20% of viscosity may not be fully generated for 10 to 20 minutes. This delay can seriously complicate measurement between rapid aerial applications. The gel produced from the dispersion of this disclosure reaches full viscosity in essentially less time than it takes to measure its value.

This description of suitable surfactants, or surfactant combinations, should in no way be considered limiting. Those skilled in the art will recognize that within the criteria for selection, there are many surfactant combinations that produce HLB ranges above 9.5 that aid in dispersing the dry polymer, lower dispersion viscosity while maintaining dispersion stability, can produce low concentration gels that reach their desired viscosity rapidly, and produce a substantive gel that is easily removed by water washing.

The surfactant system may have a net HLB value significantly greater than 9.5, and it is possible to operate according to the invention with net HLB values of above 30 with relatively inefficient surfactants, although it is preferred that the net HLB value be 16 or below, and highly preferable that the net HLB value be 12 or below.

Typically, the additive is present in sufficient quantity such that after absorption of water, the additive holds more than about 50 wt. % of the total water.

A suspending agent, such as fumed silica, may be used to provide additional stability to the dispersion. Fumed silica is also approved as a direct food additive.

Polymeric dispersions that comprise, consist essentially of, or consist of vegetable oil (e.g., canola oil), POE (20) sorbitan tristearate (T-MAZ 65K), and fumed silica are particularly desirable for health, safety, environmental and handling aspects in that these formulating components are either foods or are approved as direct food additives.

The additive is typically added to the water in a concentration of at least about 0.1 volume percent (vol. %), usually no more than about 5 vol. %. Preferably, the additive is added to the water in a concentration from about 0.1 vol. % to about 5 vol. %, and more preferably from about 1 vol. % to about 2.5 vol. %.

The additive combines the properties of a super-absorbent polymer, in that it can absorb significant quantities of water in relation to its size and weight, and a thickener, in that the resulting water-additive mixture has a relatively high viscosity. Thus, the water-additive mixture that is sprayed from the end of a fire hose adheres readily to vertical surfaces when the concentration of the dispersion in water results in sufficiently high gel viscosity. This is particularly effective in structure protection. This adherence allows the water-additive mixture to prevent the fire from igniting any of the surfaces of the structure. Further, this adherence allows the water-additive mixture to prevent the fire from damaging the surface to which it adheres for a relatively long period of time, thereby minimizing the manpower needed to recoat the structure. Using this water-additive mixture to coat a structure that is near a fire therefore provides a protective coating to the structure. Thus, the fire will not spread as rapidly because it must overcome the effects of the significant quantity of water present in the water-laden polymer particles of the additive that adhere to the structure.

Lower gel viscosities are required for ground or aerial application to forests and foliage. Here the requirement is for a water-additive mixture of sufficient, but still fluid, viscosity. For example, viscosities in the range of 600 cps to 1400 cps will film and ‘wrap’ foliage to increase the percentage of surface area coated (e.g.; tree trunks, branches and needles/leaves), thus preventing and extinguishing combustion. Additionally, because the quantity of water absorbed by the additive evaporates less quickly than that provided by pure water, use of the additive provides more water to prevent and/or extinguish fires. Furthermore, the firefighting benefits of the additive can be replenished by misting (e.g., subsequent to coating a structure with the water-additive mixture). Misting is typically performed when a portion of the water held by the polymer evaporates. When desired, the coating can be remove with simple water washing to produce an oil-free surface.

The method of adding this additive to the firefighting water is preferably via eduction, pumping, or batch addition to the source water. The nature and properties of the additive enables eduction through firefighting eduction equipment.

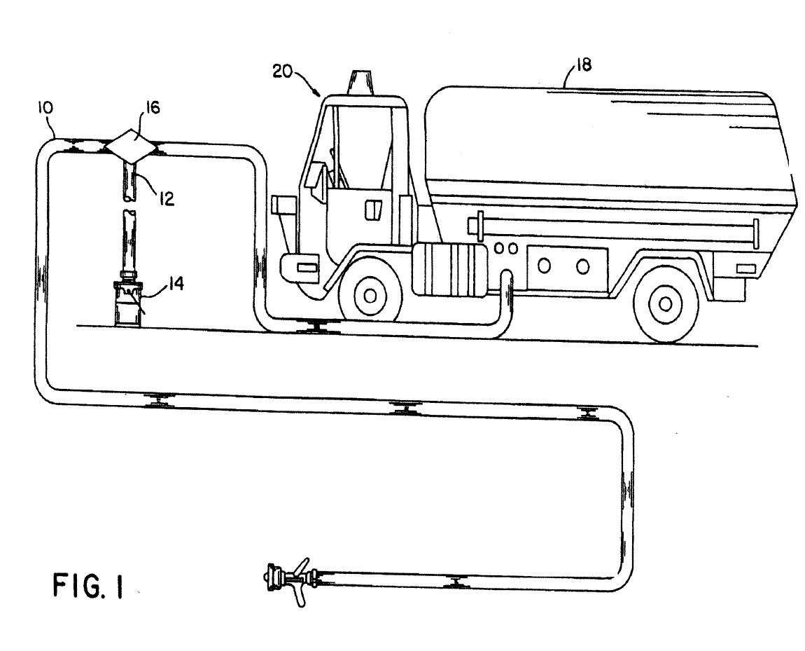

As shown in FIG. 1, the additive may be educted into a fire hose 10 in any suitable manner, such as that currently used to educt fire fighting foams, such as aqueous film-forming foam (AFFF). A trailing hose 12 is placed in a bucket 14 of additive. The flow of water through the fire hose 10 creates a negative pressure at an eductor nozzle 16, which then draws the additive from the bucket 14 into the flow of water through the fire hose 10. The eductor nozzle 16 has an internal valve by which the flow of additive may be controlled. This additive may be used with existing standard firefighting equipment and does not require purchase of new equipment. Because the additive is a flowable dispersion, there is no need to add a carrying or release agent to enable it to be educted or mixed.

Alternatively, the additive may be batch added to the water tank 18 on a fire truck 20. Once again, because the additive is a fluid dispersion, there is no need for extensive agitation or for addition of a separate carrying or release agent to avoid clumping, as is necessary with the solid additives that are presently used. Only limited mixing is typically required in such a batch addition of the additive of the disclosure.

When the additive is introduced to a significant quantity of fire fighting water such as through eduction into a fire hose or batch addition into a water tank, the dispersion mixes with the firefighting water, and the polymer particles within the dispersion are exposed to a large volume of water and quickly absorb significant quantities of the water.

The swollen particles from the vegetable oil dispersion form a homogeneous, highly viscous fluid. Because of the nature of the dispersion, the resulting water-additive mixture has a short (less than three seconds) swell or absorption time and the high viscosity, which allows the mixture to adhere to vertical surfaces. Moreover, the water-additive mixture has sufficient fluidity to allow the additive to be easily educted through professional fire fighting equipment.

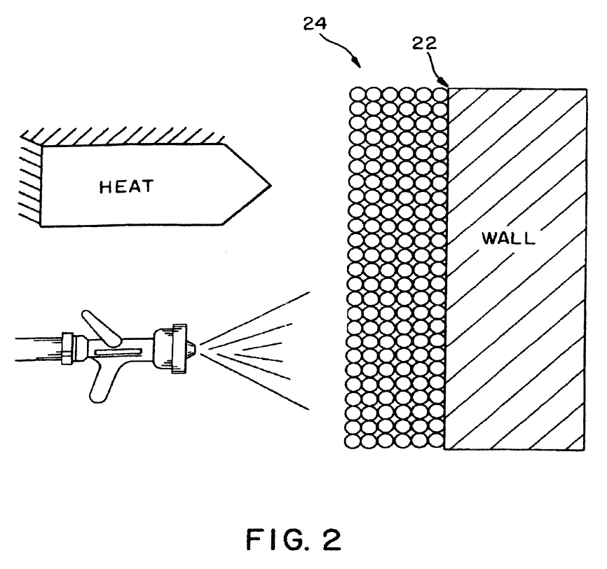

When the water-additive mixture is sprayed onto a vertical or horizontal surface, the mixture adheres to the surface, thereby extinguishing the fire and/or providing extended fire protection for structures located near a fire. As illustrated in FIG. 2, when the mixture is sprayed onto a surface 22, water-laden polymer particles 24 are stacked on top of each other. This is similar to how AFFF and other foams are used, but the polymer particles 24 are laden with water and the traditional foam bubbles are filled with air. This water fill dramatically enhances the thermal protection qualities of the additive.

When the fire approaches the surface 22, the outer water-laden polymer particles 24 that are closest to the fire absorb the heat until the point of water evaporation is reached. Thus, the water-laden polymer particles 24 that are closer to the wall are protected until the water of the outer water-laden polymer particles 24 evaporates. Then the next layer of water-laden polymer particles 24 absorbs heat until the point of water evaporation is reached, thereby shielding the remaining inner layers of water-laden polymer particles. This process continues until the water of the innermost layer of water-laden polymer particles 24 is evaporated. This process absorbs heat significantly more effectively than does the use of conventional foams that use air instead of water to absorb the heat as water has a significantly higher heat capacity than air bubbles.

Obviously, at some point the fire will evaporate substantially all of the water from the additive if the fire continues to burn. But by retarding the advance of the fire and the damage done by the fire, and by using the additive to directly fight the fire, firefighters will be able to more effectively fight the slowed fire and the damage done by the fire will be significantly reduced relative to the damage done when conventional firefighting techniques and materials are used to fight fires. Accordingly, the additive represents a substantial leap forward in firefighting technology.

As previously described, when water is sprayed directly onto a fire, much of the water never effectively fights the fire because the superheated air above the fire evaporates the water before the water can reach the flames. However, when the disclosed additive is used, more water reaches the fire because the water-laden additive polymer particles retard evaporation, the evaporation process is slower. Thus, not only does more water reach the fire, less water is used than when using simply water, or even when using conventional additives, such as fire fighting foams. Also, when simply applying water, a larger proportion of the water that is applied directly to the fire (and is not evaporated) runs off or soaks into the ground and is thus wasted after its initial application. As an additional benefit, the water-additive mixture of the disclosure also coats the ashes or the charred structure that was burning, instead of running off or soaking into the ground, and helps to prevent re-flashing, because the water-laden polymer particles are able to absorb heat and the mixture, which is viscous, adheres to the surface and deprives the surface of the oxygen needed for combustion, thus also providing a smothering effect on the burned surface.

Because of these properties of the additive, the water-additive mixture is also suitable for use as an artificial fire break when fighting forest or brush fires. The mixture can be sprayed in advance of the fire and will coat the structure, such as bushes and trees, such that the fire will stop its advance when it reaches the treated area, allowing the firefighters to extinguish the flames without the fire advancing further. This causes significantly less damage than does the use of conventional means of fire breaks, such as using bulldozers or controlled burning to clear an area for a fire break.

The additive can absorb water in significant quantities relative to its own weight. Once the additive particles have been added to the firefighting water and absorb water to their capacity (preferably in three seconds or less), the particles can carry more than about 90 wt. % of the water that is used to fight the fire.

The polymer is preferably a dry, ground, cross-linked, water-soluble polymer in a vegetable oil dispersion. The polymer may be a polymer of hydrophilic monomers, such as acrylamide, acrylic acid derivatives, maleic acid anhydride, itaconic acid, 2-hydroxylethyl acrylate, polyethylene glycol dimethacrylate, allyl methacrylate, tetraethyleneglycol dimethacrylate, triethyleneglycol dimethacrylate, diethylene glycol dimethacrylate, glycerol dimethacrylate, hydroxypropyl methacrylate, 2-hydroxyethyl methacrylate, 2-tert-butyl amino ethyl methacrylate; dimethylaminopropyl methacrylamide, 2-dimethylaminoethyl methacrylate, hydroxypropyl acrylate, trimethylolpropane trimethacrylate, 2-acrylamido-2 methylpropanesulfonic acid derivatives, and other hydrophilic monomers. Preferably, the polymer is a co-polymer of acrylamide and acrylic acid derivatives and, more preferably, a terpolymer of an acrylate salt, acrylamide, and a 2-acrylamido-2-methylpropanesulfonic acid (AMPS) salt. The salts may generally be any monovalent salt, but preferably are sodium or potassium salts.

Many such dry polymers are commercially available and are routinely used in diapers. A viscosity of significantly greater than 100 cps and even in the range from 500 cps to 50,000 cps is easily obtainable and beneficially utilized for the disclosed additive. This is in contrast with the state of the art as represented by U.S. Pat. No. 5,190,110 to von Blucher et al., which teaches that viscosities above 100 cps are undesirable and unworkable in fighting fires. The higher viscosities of the water-additive mixture allow the water-additive mixture to have better adherence to vertical surfaces, yet the water-additive mixtures are still sufficiently fluid such that the additive can be successfully educted through professional firefighting equipment.

Because the degree of hardness of the water, in other words the amount of divalent cations in the water, affects the degree of swelling of the polymer particles, a component may also be introduced to counteract water hardness. A suitable monomer to counteract water hardness in this application is AMPS or a derivative thereof. The amount of AMPS included in the dry polymer may be varied depending on the hardness of the water in the particular region of use. Nevertheless, the polymer is effective without inclusion of a chemical to counteract water hardness, particularly in geographical regions that do not have hard water.

The polymer particle size in the dispersion is preferably 97% less than 20 microns/100% less than 30 microns and a mean value of about 9.2 microns. The particle size of the polymer allows for a preferred swell time of less than three seconds.

The preferred method of preparing the additive is to utilize an addition sequence in which a relatively low HLB (e.g., 5 or less) is mixed with the vegetable oil, followed by addition of dry polymer and optional stabilizing agent (the low HLB surfactant aids in dispersion of the polymer in oil). The mixture is then homogenized and a relatively high HLB surfactant or surfactant mixture is added to the mixture. Relative amounts and HLB values of surfactant components are selected such that the net HLB value of the resulting additive is about 9.5 or more.

Because of the short swell time and the fluid state of the disclosed additive, the additive is superbly situated to be used in a firefighting eduction system with a fire hose and a water source, such as a tanker truck or a fire hydrant. This eliminates the need for special equipment to practice the methods of the disclosure. The disclosure is also suitable for use by directly adding the additive to a tank of a tanker truck. To this end, only 8 gallons to 12 gallons of additive (i.e., generally less than 100 lbs.) are necessary to treat the standard 500 gallon tank on a fire tanker truck. This is a significant improvement over the state of the art, as illustrated by the '460 patent to von Blücher et al., wherein 200 grams of additive are required for every liter of water, which is equivalent to about 835 pounds for a typical 500 gallon tank.

### EXAMPLES

Three dispersion formulations were prepared so as to compare the dispersion of Sortwell '337 with two dispersions that are the product of this disclosure. The polymer content of the three formulations was identical. Further, in order to evaluate only the HLB/surfactant differences between this disclosure and Sortwell '337, the finer grind of polymer of this disclosure was used in all three formulations so as to not skew the results.

Formula 1 [formulation (4) in Sortwell '337, column 9]:
38.2 wt. % polymer,
2.4% wt. % sorbitan monooleate (HLB 4.3),
1.7 wt. % fumed silica,
57.8 wt. % canola oil.
Note: Net HLB of the formulation is 4.3

Formula 2 [this disclosure]:
38.20 wt. % polymer,
0.56 wt. % sorbitan monooleate (HLB 4.3),
0.69 wt. % fumed silica,
55.79 wt. % canola oil,
4.76 wt. % surfactant blend (61.5 wt. % TERGITOL 15-S-7,
38.5 wt. % TERGITOL 15-S-3: net HLB of blend 10.52).
Note: Net HLB of the formulation is 9.87

Formula 3 [this disclosure]:
38.2 wt. % polymer,
0.56 wt. % sorbitan monooleate (HLB 4.3),
0.69 wt. % fumed silica,
55.79 wt. % canola oil,
4.76 wt. % T-MAZ 65K.
Note: Net HLB of the formulation is 10.3

### Example 1

The viscosity of each of the three formulae was measured by Brookfield rotational viscometer:

| | |
|---|---|
| Formula 1 (Sortwell ′337) | 6200 cps |
| Formula 2 (this disclosure) | 1120 cps |
| Formula 3 (this disclosure) | 1340 cps |

### Example 2

2.2 volume % of each of the three formulae, above, was prepared with 1 second flash mix in a blending apparatus. The three gels were then spread onto ¼ inch thick poplar boards to equal thickness by draw-down technique. Formulae 2 and 3 produced slightly more viscous gels but all three gels clung to the vertical boards. All three gels were subjected to identical open flame generated by a propane gas jet over half of their coated surfaces. An uncoated area of board was also exposed to the flame and it burst into flame in 4 seconds. All three gels gave excellent protection but, in this test, the flame impingement was limited to 3½ minutes so as to not burn through the coatings. This simulates a coated structure exposed to fire, but protected from burning. All three boards were gently rinsed with water after the flame exposure. The two gels of this disclosure (Formulae 2 and 3, above) rinsed off easily from both the flame-impinged and the non-heated areas, leaving no oily film (by touch).

The gel of Formula 1, above, was not moved by the gentle rinsing and a stronger stream of water was applied. Even after five minutes of water flow, an oily film remained.

### Example 3

The test of Example 2 was repeated and the coated area of each board marked before removing the coating. After rinsing with water sufficient to remove the coatings, the test boards were allowed to dry. The test boards were then painted with latex house paint and allowed to air-dry overnight. The paint adhered well to the previously coated areas of Formulae 2 and 3, but was easily removed from the test area of Formula 1.

### Example 4

1 wt. % gels of each of the three formulae were prepared by one second flash mixing in a blending apparatus. Each gel was immediately transferred to a cup for viscosity measurement by a Brookfield rotational viscometer. Rotational viscometers require one minute before equilibration. At one minute the viscosity of Formula 1 was 670 cps and the viscosity continued to increase until it stabilized after twenty minutes at 1110 cps. Formula 2 was 1100 cps at one minute and stabilized at 1190 cps after two minutes. Formula 3 was 1060 cps at one minute and stabilized at 1150 cps after 3½ minutes.

It can be clearly seen that the formulations of this disclosure are a considerable improvement over Sortwell '337 insofar as the formulations of the disclosure are stable yet much more fluid and therefore more easily pumped, they produce excellent fire protective gels at the same or lower concentrations, they produce gels that reach their full viscosity in less time and they are easily removed from surfaces and leave no residual oil film.

In application, the concentration of additive is preferably between 0.1% and 5% (volume to volume). Once the concentration is significantly above 5 vol. %, the viscosity of the water-additive mixture often becomes unwieldy. Likewise, for use in direct mixing into a tank, the additive is batch mixed in a concentration of preferably between 0.1 vol. % and 5 vol. %. Additive concentrations of from about 1.0 vol. % to about 3.0 vol. % generally provide suitable characteristics for firefighting, and greater concentrations are usually unnecessary except in cases of very hard water.

What is claimed is:

1. A method for applying water-laden polymer particles to a surface to prevent and/or extinguish a fire, the method comprising:
(a) adding a dispersion comprising a vegetable oil, a surfactant system having a net hydrophilic/lipophilic balance (HLB) value above 9.5, and a dry, ground, cross-linked, water-swellable polymer to water to form a water-additive mixture containing water-laden polymer particles, the oil, the particle size of the polymer, and amount of the polymer being selected to result in the formation of a gel that is easily removable from a surface by washing with water; and,
(b) directing the water-additive mixture onto a surface to prevent and/or extinguish a fire.

2. The method of claim 1, wherein the dispersion further comprises at least one stabilizing agent.

3. The method according to claim 2, wherein the stabilizing agent is fumed silica.

4. The method of claim 1, wherein the dispersion is added in an amount sufficient to increase the viscosity of the water-additive mixture to above 100 centipoises (cps).

5. The method according to claim 1, wherein the vegetable oil is rapeseed oil.

6. The method according to claim 1, wherein the surfactant system has a net HLB value of 16 or less.

7. The method according to claim 1, wherein the surfactant system has a net HLB value of 12 or less.

8. The method of claim 1, wherein adding comprises educting the dispersion into the water with firefighting educting equipment.

9. The method of claim 1, wherein adding comprises batch-adding the dispersion to the water with mixing.

10. The method of claim 1, wherein the polymer has a swell time of less than three seconds.

11. The method of claim 1, wherein the dispersion is added in an amount sufficient to increase the viscosity of the water-additive mixture to between about 500 cps and about 50,000 cps.

12. The method of claim 1, wherein the dispersion is added in an amount sufficient to increase the viscosity of the water-additive mixture to between about 600 cps and 1400 cps.

13. The method of claim 1, wherein the polymer is formed from at least one hydrophilic monomer.

14. The method of claim 13, wherein the hydrophilic monomer is selected from the group consisting of acrylamides and acrylic acid derivatives.

15. The method of claim 14, wherein the hydrophilic monomer is an acrylate salt.

16. The method of claim 1, wherein the polymer is a terpolymer of an acrylate salt, acrylamide, and a 2-acrylamido-2-methylpropanesulfonic (AMPS) acid salt.

17. The method of claim 1, wherein a concentration of the dispersion of the water-additive mixture is at least about 0.01 percent by volume (vol. %).

18. The method of claim 1, wherein a concentration of the dispersion of the water-additive mixture is between about 0.1 vol. % and about 5 vol. %.

19. The method of claim 1, wherein a concentration of the dispersion of the water-additive mixture is between about 1 vol. % and about 2.5 vol. %.

20. The method of claim 1, wherein the dry polymer has a particle size of about 97% less than 20 microns/about 100% less than 30 microns and a mean value of about 9.2 microns.
